(19) United States
(12) Patent Application Publication
(10) Pub. No.: US 2008/0218493 A1
(43) Pub. Date: Sep. 11, 2008

(54) Display With Motion Sensor

(75) Inventors: Daniel Patten, Pleasant Grove, UT (US); Scott Chandler, Payson, UT (US); Paul T. Clegg, American Fork, UT (US); John McDaniel, Cedar Hills, UT (US)

Correspondence Address: MCCARTER & ENGLISH , LLP STAMFORD OFFICE, FINANCIAL CENTRE , SUITE 304A, 695 EAST MAIN STREET, STAMFORD, CT, 06901-2138, US

(73) Assignee: VANTAGE CONTROLS, INC., Orem, UT (US)

(21) Appl. No.: 12/118,318

(22) Filed: May 9, 2008

Related U.S. Application Data
(63) Continuation-in-part of application No. 10/934,332, filed on Sep. 3, 2004, now Pat. No. 7,394,451.
(60) Provisional application No. 60/500,146, filed on Sep. 3, 2003.

(51) Int. Cl. G09G 5/00

(52) U.S. Cl. 345/173; 345/204; 340/686.6; 340/573.1

(57) ABSTRACT

The present disclosure provides for a display device for interfacing with a control and/or automation system. More particularly, the present disclosure provides for an improved display device for interfacing with a control and/or automation system, wherein the electronic display device includes a motion sensor or the like. In exemplary embodiments, the motion sensor is configured to detect at least one of motion or proximity of a human being without being contacted by the human being, the non-contact motion sensor also being configured to activate and/or adjust the illumination/light level of the display/screen from a first illumination/light level to a second illumination/light level when the non-contact motion sensor detects at least one of motion or proximity of a human being.

### CROSS REFERENCE TO RELATED APPLICATIONS

The present application is a continuation-in-part application that claims the benefit of co-pending U.S. patent application Ser. No. 10/934,332, filed Sep. 3, 2004, which claims the benefit of U.S. Provisional Application No. 60/500,146, filed Sep. 3, 2003, the entire contents of each being hereby incorporated by reference.

### TECHNICAL FIELD

The present disclosure relates generally to display devices. More particularly, the present disclosure relates to an electronic display device for interfacing with a control and/or automation system, wherein the electronic display device includes a motion sensor or the like.

### BACKGROUND

In general, display devices, such as, for example, electronic display devices, are used in a variety of applications (e.g., computers, televisions, instrumentation, control and/or automation systems, etc.). Examples of typical display devices (e.g., electronic display devices) include, without limitation, liquid crystal displays (LCDs) or screens, light-emitting diode (LED) displays or screens, organic light-emitting diode (OLED) displays or screens, plasma or plasma display panel (PDP) displays or screens, and cathode ray tube (CRT) displays or screens. In general, display devices may be integrated with and/or into control and/or automation systems.

However, display devices may be expensive and/or complex. For example, it may be difficult and/or complex to integrate a display device with and/or into a control and/or automation system. In addition, the displays or screens of display devices are typically brightened or illuminated (e.g., self-illuminated, and/or illuminated/brightened with a front and/or backlight or the like) so that the image displayed on the display device may be seen by a viewer. In general, the brightness or illumination level of the display or screen must be at a certain level in order for a viewer to see the image. One problem in the art is that the display device itself (e.g., self-illuminated display devices and/or display devices having their illumination/brightness levels integral to the display/screen) and/or the illumination means of the display device (e.g., display devices illuminated/brightened with a front and/or backlight or the like) may have a limited life. In general, replacement of the display device and/or illumination means of the display device is expensive and/or complex.

Typically, in designing a display device, a designer has to consider a number of design parameters. For example, the rated life of the display device and/or illumination means of the display device is a factor, since frequent replacement of the display device and/or illumination means is typically costly and/or time consuming. Further design concerns may include the operating temperature of the display device, the power consumption of the display device, and/or the amount of electromagnetic interference generated by the display device.

In addition, display devices are typically activated/deactivated by touching/contacting the display or screen itself of the display device, and/or by touching/contacting an activation/deactivation button or the like associated with the display device.

Despite efforts to date, a need remains for cost-effective, efficient display devices for interfacing with a control and/or automation system, wherein the electronic display device includes a motion sensor or the like. These and other inefficiencies and opportunities for improvement are addressed and/or overcome by the systems and methods of the present disclosure.

### SUMMARY

The present disclosure provides an advantageous display device for interfacing with a control and/or automation system. In exemplary embodiments, the present disclosure provides for an improved electronic display device for interfacing with a control and/or automation system, wherein the electronic display device includes a motion sensor or the like. In exemplary embodiments, the motion sensor is configured to detect at least one of motion or proximity of a human being without being contacted by the human being, the non-contact motion sensor also being configured to activate and/or adjust the illumination/light (e.g., intensity) level of the display/screen from a first illumination/light level to a second illumination/light level when the non-contact motion sensor detects at least one of motion or proximity of a human being.

The present disclosure provides for a display device including a screen adapted to display information related to an automation system, the screen having adjustable illumination levels that include at least a first illumination level and a second illumination level; a non-contact motion sensor configured to detect at least one of motion or proximity of a human being without being contacted by the human being; and wherein the non-contact motion sensor is configured to activate or adjust the illumination level of the screen from the first illumination level to the second illumination level when the non-contact motion sensor detects at least one of motion or proximity of a human being.

The present disclosure also provides for a display device wherein the screen is selected from the group consisting of a liquid crystal display (LCD) screen, a light-emitting diode (LED) screen, an organic light-emitting diode (OLED) screen, a plasma or plasma display panel (PDP) screen and a cathode ray tube (CRT) screen. The present disclosure also provides for a display device wherein the screen further comprises a touchscreen. The present disclosure also provides for a display device wherein the screen is a self-illuminating screen.

The present disclosure also provides for a display device wherein the non-contact motion sensor is selected from the group consisting of a pyro infra-red (PIR) sensor, a RF field disruption sensor, a capacitive field change sensor, a light level sensor, a reflective light measurement sensor and an acoustic sensor. The present disclosure also provides for a display device wherein the screen is in communication with at least one master controller of the automation system, and wherein the screen further comprises a station bus configured to allow two-way communication between the screen and the master controller.

The present disclosure also provides for a display device wherein the screen further comprises at least one auxiliary input configured to receive data from external devices. The present disclosure also provides for a display device wherein the first illumination level is non-illuminated. The present disclosure also provides for a display device wherein the non-contact motion sensor has adjustable motion or proximity sensitivity levels. The present disclosure also provides for a display device further including a first screen illumination level control configured to allow a user to adjust the illumination of the first illumination level; and a second screen illumination level control configured to allow a user to adjust the illumination of the second illumination level.

The present disclosure also provides for a display device further including a housing and an IR receiver; and wherein the screen, non-contact motion-sensor and IR receiver are mounted with respect to the housing. The present disclosure also provides for a display device wherein the IR receiver is configured to receive command signals from a remote to control at least one electrical device connected to the automation system.

The present disclosure also provides for a display device further including a communications port mounted with respect to the housing. The present disclosure also provides for a display device further including a non-contact motion sensor control configured to allow a user to adjust the sensitivity level of the non-contact motion sensor. The present disclosure also provides for a display device wherein the screen further comprises at least one of the following: an external power supply input, at least one auxiliary input and a station bus. The present disclosure also provides for a display device further including a housing; a first antenna in communication with at least one master controller of the automation system, the first antenna configured to send load control or status information to the master controller and to receive load control or status information from the master controller; and wherein the screen, non-contact motion sensor and first antenna are mounted with respect to the housing.

The present disclosure also provides for a display device further including a second antenna in communication with a docking station, the second antenna configured to receive audio or video data from the docking station. The present disclosure also provides for a display device wherein the housing is configured and dimensioned to be hand-held by a user. The present disclosure also provides for a display device wherein the housing further includes at least one connection configured to allow a user to releasably engage the housing to a docking station. The present disclosure also provides for a display device further including an IR receiver mounted with respect to the housing. The present disclosure also provides for a display device further including a light sensor mounted with respect to the housing.

The present disclosure also provides for a display device further including a housing; a radio transceiver in communication with a docking station, the radio transceiver configured to receive video or audio data from the docking station; a radio transmitter in communication with at least one master controller of the automation system, the radio transmitter configured to send load control signals to the at least one master controller of the automation system; and wherein the screen, non-contact motion sensor, radio transceiver and radio transmitter are mounted with respect to the housing.

The present disclosure also provides for a display device including a screen adapted to display information related to an automation system, the screen having adjustable illumination levels that include at least a first illumination level and a second illumination level; a non-contact motion sensor configured to detect at least one of motion or proximity of a human being without being contacted by the human being; wherein the non-contact motion sensor is configured to activate or adjust the illumination level of the screen from the first illumination level to the second illumination level when the non-contact motion sensor detects at least one of motion or proximity of a human being; and wherein the motion sensor is configured to adjust the screen illumination from the second illumination level to the first illumination level after a specific amount of time has elapsed from when the non-contact motion sensor last detected at least one of motion or proximity of a human being. The present disclosure also provides for a display device wherein the specific amount of time may be adjusted.

The present disclosure also provides for a display device including a display means for displaying information related to an automation system, the display means having adjustable illumination levels that include at least a first illumination level and a second illumination level; a non-contact sensor means for detecting at least one of motion or proximity of a human being without being contacted by the human being; and wherein the non-contact sensor means is configured to activate or adjust the illumination level of the screen from the first illumination level to the second illumination level.

Additional advantageous features, functions and applications of the disclosed systems and methods of the present disclosure will be apparent from the description which follows, particularly when read in conjunction with the appended figures.

### BRIEF DESCRIPTION OF THE DRAWINGS

To assist those of ordinary skill in the art in making and using the disclosed systems and methods, reference is made to the appended figures, wherein:

FIG. 1 illustrates an embodiment of an automation or control system according to the present disclosure;

FIG. 2 provides a front view of an embodiment of the present disclosure;

FIG. 3 shows a side view of an embodiment of the present disclosure;

FIG. 4 shows a back view of an embodiment of the present disclosure;

FIG. 5 shows a view of mounting wings used to secure an embodiment of the present disclosure to a wall;

FIG. 6 shows an illustrative example of a page that can be displayed on an embodiment of the present disclosure;

FIG. 7 shows one illustrative embodiment of a faceplate of the present disclosure;

FIG. 8 illustrates a block diagram of a portable display and a docking station of the present disclosure;

FIGS. 9A-9F illustrate a schematic diagram for an embodiment of the present disclosure;

FIG. 10A-10H illustrate a schematic diagram for an embodiment of the present disclosure;

FIG. 11A-11D illustrate a schematic diagram for an embodiment of the present disclosure;

FIG. 12A-12B illustrate a schematic diagram for an embodiment of the present disclosure;

FIG. 13A-13B illustrate a schematic diagram for an embodiment of the present disclosure;

FIG. 14 provides a front view of another embodiment of the present disclosure;

FIG. 15 provides a back view of another embodiment of the present disclosure; and

FIG. 16 provides a back view of another embodiment of the present disclosure.

### DETAILED DESCRIPTION

The present disclosure provides for a display device for interfacing with a control and/or automation system. More particularly, the present disclosure provides for an improved display device for interfacing with a control and/or automation system, wherein the display device includes a motion sensor or the like. In exemplary embodiments, the motion sensor is configured to detect at least one of motion or proximity of a human being without being contacted by the human being, the non-contact motion sensor also being configured to activate and/or adjust the illumination/light (e.g., intensity) level of the display/screen from a first illumination/light level to a second illumination/light level when the non-contact motion sensor detects at least one of motion or proximity of a human being.

Current practice provides that some display devices (e.g., self-illuminated display devices and/or display devices having their illumination/brightness levels integral to the display/screen) and/or the illumination means of some display devices (e.g., display devices illuminated/brightened with a front and/or backlight or the like) have a limited life, and frequent replacement of the display device and/or illumination means is typically costly and/or complex. In addition, the power consumption and operating temperature of display devices are examples of factors, among others, that are typically considered when designing a display device. Furthermore, display devices are typically activated/deactivated by touching/contacting the display or screen itself of the display device, and/or by touching/contacting an activation/deactivation button or the like associated with the display device.

In exemplary embodiments, the present disclosure provides for a display device for interfacing with a control and/or automation system, wherein the electronic display device includes a motion sensor, and wherein the motion sensor is configured to detect at least one of motion or proximity of a human being without being contacted by the human being, the non-contact motion sensor also being configured to activate and/or adjust the illumination/light (e.g., intensity) level of the display/screen from a first illumination/light level (e.g., a dim and/or power-saving level) to a second illumination/light level (e.g., a user viewable level) when the non-contact motion sensor detects at least one of motion or proximity of a human being, thereby providing a cost-effective and a significant commercial advantage as a result.

In one embodiment, the present disclosure provides for a display device including a screen adapted to display information related to an automation system, the screen having adjustable illumination levels that include at least a first illumination level and a second illumination level; a non-contact motion sensor configured to detect at least one of motion or proximity of a human being without being contacted by the human being; and wherein the non-contact motion sensor is configured to activate or adjust the illumination level of the screen from the first illumination level to the second illumination level when the non-contact motion sensor detects at least one of motion or proximity of a human being.

For the purposes of promoting an understanding of the principles in accordance with the disclosure, reference will now be made to the embodiments illustrated in the drawings and specific language will be used to describe the same. It will nevertheless be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure claimed.

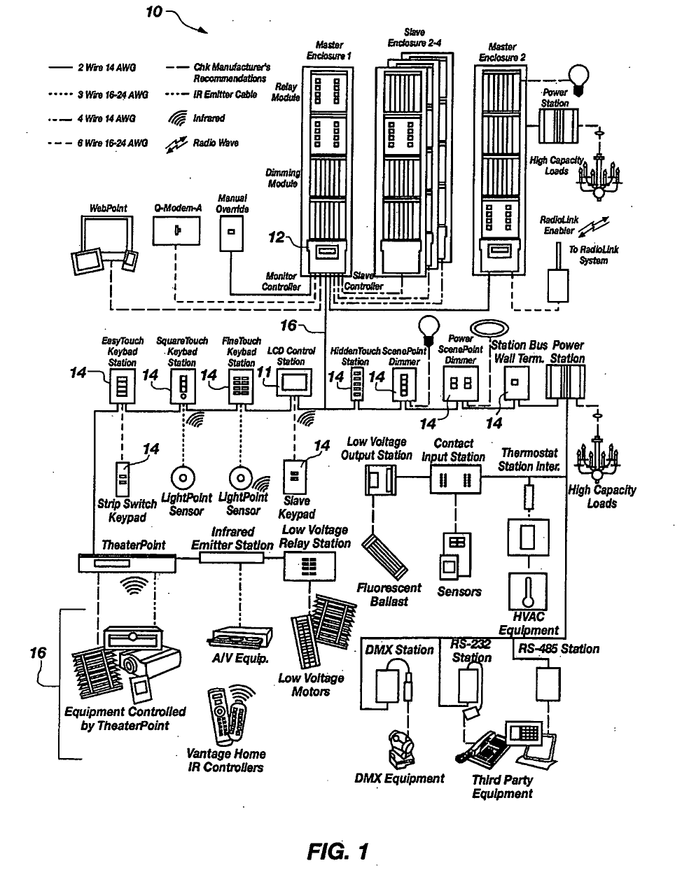

Referring now to FIG. 1, there is shown a control and/or automation system 10 in which a display device 11 may be used. Exemplary control and/or automation system 10 is a home automation system 10, although the present disclosure is not limited thereto. Rather, it is to be appreciated that the present disclosure is applicable to many different control and/or automation systems 10 including, without limitation, residential and commercial control and/or automation systems 10, and other types of control and/or automation systems 10. In an exemplary embodiment, display device 11 of control and/or automation system 10 is an electronic display device, such as, for example, a liquid crystal display (LCD) device, a light-emitting diode (LED) display device, an organic light-emitting diode (OLED) display device, a plasma or plasma display panel (PDP) display device, or a cathode ray tube (CRT) display device. Display device 11 may or may not include a touchscreen (e.g., a LCD touchscreen display device or the like).

In FIG. 1, the control and/or automation system 10 includes a master controller 12. In general, the master controller 12 may control electrical devices, known as loads, connected into the control and/or automation system 10. Loads may include lights and other electrical devices typically found in a home, for example. The system 10 also includes a number of stations 14. Each station 14 may include one or more buttons. Each button may be programmed to control any load, or multiple loads, connected to the system 10.

The display device 11 can be programmed to allow a user to control any of the electrical devices connected to the system 10. This may include home theater system components 16. The display device 11 may be located in a central room of a house, such as, for example, a bedroom or a kitchen. From this location, most if not all of the electrical devices may be controlled or monitored. The display device 11 can also be programmed to display other information such as room temperature, etc.

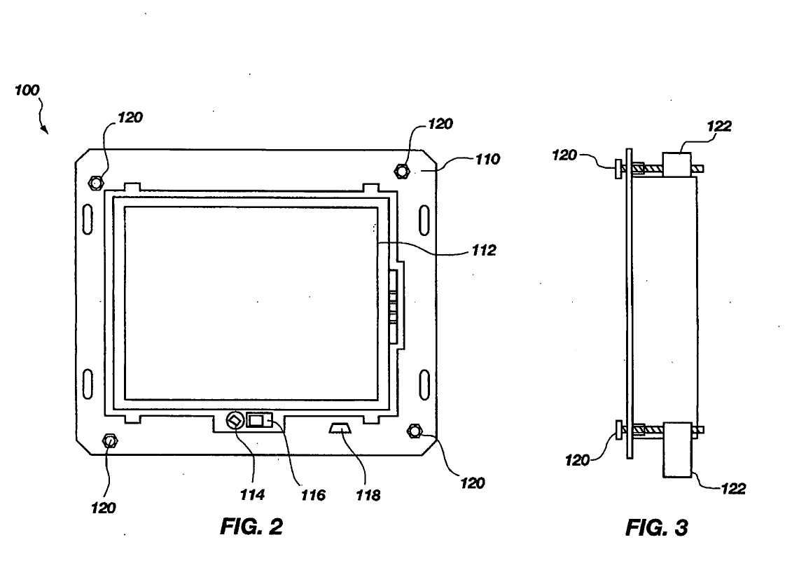

Referring now to FIG. 2, there is shown one embodiment of a display device 100 in accordance with the principles of the present disclosure. In general, a housing 110 encases a screen or display 112. The housing 110 of display device 100 may also include a motion sensor 114 (e.g., an integrated motion sensor 114), an IR receiver 116 and a communications port 118.

In exemplary embodiments, screen or display 112 of display device 100 is adapted to display information related to control and/or automation system 10, with the screen or display 112 having adjustable illumination or light levels that include at least a first illumination or light level and a second illumination or light level. Screen or display 112 of display device 100 may include a screen/display illumination or light source (e.g., a front or backlight) configured to adjust screen/display illumination or light levels. For example, screen or display 112 may include, without limitation, a LCD screen/display illumination or light source (e.g., a front and/or backlight), a LED screen/display illumination or light source, an OLED screen/display illumination or light source, a plasma or PDP screen/display illumination or light source and a CRT screen/display illumination or light source.

In exemplary embodiments of the present disclosure, display device 100 may be a self-illuminating display device (e.g., a display device which does not require a front and/or backlight), and/or a display device having illumination or light levels integral to the display/screen 112. For example, display device 100 may be a LED display device having a LED screen/display 112, wherein the LED screen/display 112 is the illumination means or source for the LED screen/display 112. In exemplary embodiments, display device 100 may be, without limitation, a self-illuminating LED display device, a self-illuminating OLED display device, a self-illuminating plasma or PDP display device, or a self-illuminating CRT display device. In addition, the display device 100 may or may not include a front and/or backlight. For example, display device 100 may be a LCD display device having a LCD screen/display 112 with a front and/or backlight as the illumination means or source for the LCD screen/display 112.

The screen or display 112 may be of any type. Examples of a suitable screen or display 112 include, without limitation, a LCD screen/display, a LED screen/display, an OLED screen/display, a plasma or PDP screen/display and a CRT screen/display.

In one embodiment, the screen/display 112 is a 65,536 color, active matrix liquid crystal touchscreen with a backlit display, although the present disclosure is not limited thereto. For example, a quarter VGA LCD 5.5 inch diagonal screen/display may be small enough to keep any area from feeling cluttered, and versatile enough to fulfill the needs of many applications. In an alternative embodiment, display device 100 may be an OLED display device having an OLED screen/display 112 (e.g., without a front and/or backlight), wherein the OLED screen/display 112 is the illumination means or source for the OLED screen/display 112.

In exemplary embodiments, the screen/display 112 displays menus, choices, buttons, sliders, etc. on a series of preprogrammed pages, which will be explained in detail below. The screen/display 112 may or may not be a touchscreen. In addition, the screen/display 112 may or may not have a touchscreen attached to the screen/display 112, and/or to the display device 100. In an exemplary embodiment, the screen/display 112 is a touchscreen (or has a touchscreen attached), and a user can scroll through the different pages or make choices by “touching” the screen. Each touch represents a button push. Each button may control a load connected through system 10. In an alternative embodiment, display device 100 does not include a touchscreen.

In exemplary embodiments of the present disclosure, display device 100 includes a motion sensor 114. The motion sensor 114 may be integrated into, or mounted with respect to, housing 110 of display device 100. In one embodiment, motion sensor 114 is a non-contact motion sensor 114. In exemplary embodiments, motion sensor 114 is a non-contact motion sensor 114 configured to detect at least one of motion or proximity of a human being without being contacted by the human being, with the non-contact motion sensor 114 also being configured to activate and/or adjust the illumination/light level of the display/screen 112 from a first illumination or light level to a second illumination or light level when the non-contact motion sensor 114 detects at least one of motion or proximity of a human being. For example, the illumination/light level of the second illumination/light level may be greater or less than the illumination/light level of the first illumination/light level.

For example, the motion sensor 114 may detect the proximity of a human being and activate (e.g., turn on or off) and/or modify (e.g., increase or decrease) the illumination and/or intensity level of the screen/display 112. In general, the illuminated/lighted screen/display 112 allows a user to see the items on the screen/display 112. The use of the motion sensor 114 saves energy as well as extending the rated life of the display device 100. It will be appreciated that this advantageously eliminates and/or reduces the need for a person to actually touch the screen/display 112 in order to activate and/or modify the illumination/light level of the screen/display 112. For example, this is particularly advantageous at night where a person may not know the exact location of the screen/display 112. For example, by simply moving into the proximity of the screen/display 112, the screen/display 112 automatically illuminates (e.g., adjusts and/or increases its illumination/light level), thereby allowing a person to easily locate and/or view the screen/display 112.

Exemplary motion sensor 114 takes the form of a pyro infra-red (PIR) sensor, although the present disclosure is not limited thereto. Rather, motion sensor 114 may take many forms, including, without limitation, a RF field disruption sensor, a capacitive field change sensor, a light level sensor, a reflective light measurement sensor, and an acoustic sensor.

In general, the IR receiver 116 accepts commands from a remote control to control loads connected to the system 10. From the remote, it is possible to control any of the loads on the system 10 (FIG. 1).

The communications port 118 may be used to download customized pages and other information to the display device 100. The communications port 118 may be a USB port (e.g., a mini-USB port). Programming of the customized pages may be done on a computer using a computer program. The pages are generally customized for each particular home in which the display device 100 will be installed. As mention previously, through the pages, the display device 100 can control electrical devices connected to the system 10 or display status information, such as, for example, the status of a electrical device, e.g., on or off, or other information from other systems, e.g., alarm systems, or from sensors, e.g., temperature readings. Moreover, the pages can be used to control lighting, home theater components (DVD, TV, projectors), audio equipment and other electrical devices on a system 10.

For example, programming the pages may be conveniently accomplished by connecting a laptop to the display device 100 through an integrated communications port 118. In exemplary embodiments, this connection programming software allows the installer to quickly and easily create custom interfaces. Generally, the programming software comprises a library of interface components that is available to the installer, or custom images may be easily imported and connected to specific actions. For example, the programming and screen customization should be adapted or configured so that little or no training is needed.

In exemplary embodiments of the present disclosure, fasteners 120 of display device 100 allow the display device 100 to be mounted with respect to a surface (e.g., with respect to a wall surface). Fasteners 120 may include, for example, lag bolts, screws, nails etc.

In exemplary embodiments and as shown in FIG. 3, display device 100 may include fasteners 120 having mounting wings 122. For example, once a hole in the wall has been cut, the display device 100 may be inserted into the hole. The mounting wings 122 may then be deployed to hold the display device 100 in place as shown in FIG. 5.

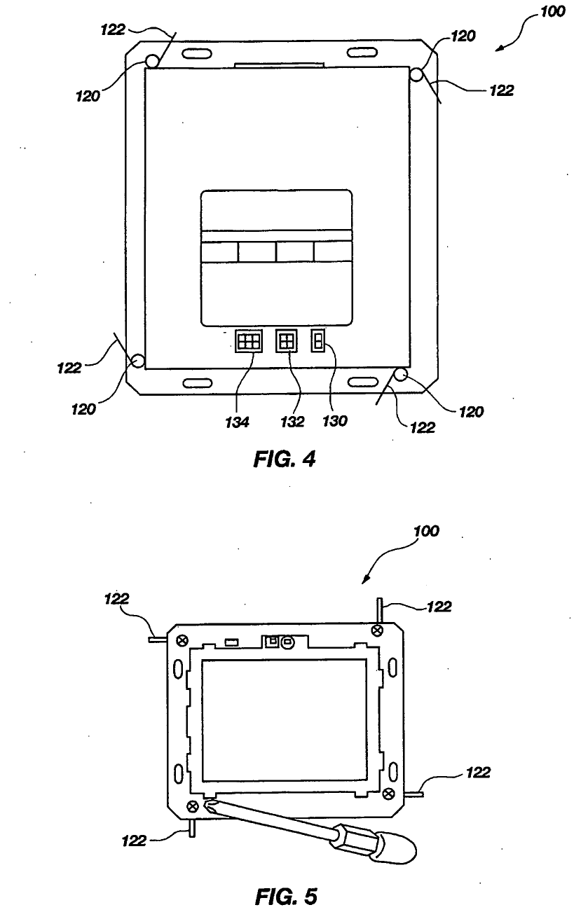

FIG. 4 illustrates a back view of the embodiment represented in FIGS. 2 and 3. A station bus 130, an external power input 132, and auxiliary connections 134 are shown. Each of these will be explained below.

Typically, the station bus 130 allows the display device 100 to be connected to the system 10 (FIG. 1). In one illustrative embodiment, the bus 130 is a two-wire bus. In general, the station bus 130 allows the display device 100 to have two-way communication with the master controller 12 (see FIG. 1). In one mode of operation, the display device 100 is powered through the station bus 130.

The external power input 132 allows an external power supply to be used to power the display device 100. In one mode of operation, the display device 100 may operate on power supplied over the station bus 130. However, while acceptable, this may reduce the power available for other devices on the system 10. This reduction in power may limit the number of other devices that can be connected to the system 10. The use of an external power supply therefore may not deplete system power.

The auxiliary connections 134 may be used to attach ancillary devices. These devices may include, for example, light sensors, infrared sensors, motion sensors, etc., all of which can communicate through the auxiliary connector. The auxiliary connections 134 may also include contact inputs. The system 10 may be programmed to execute a command or a series of commands upon data received through the auxiliary connections 134.

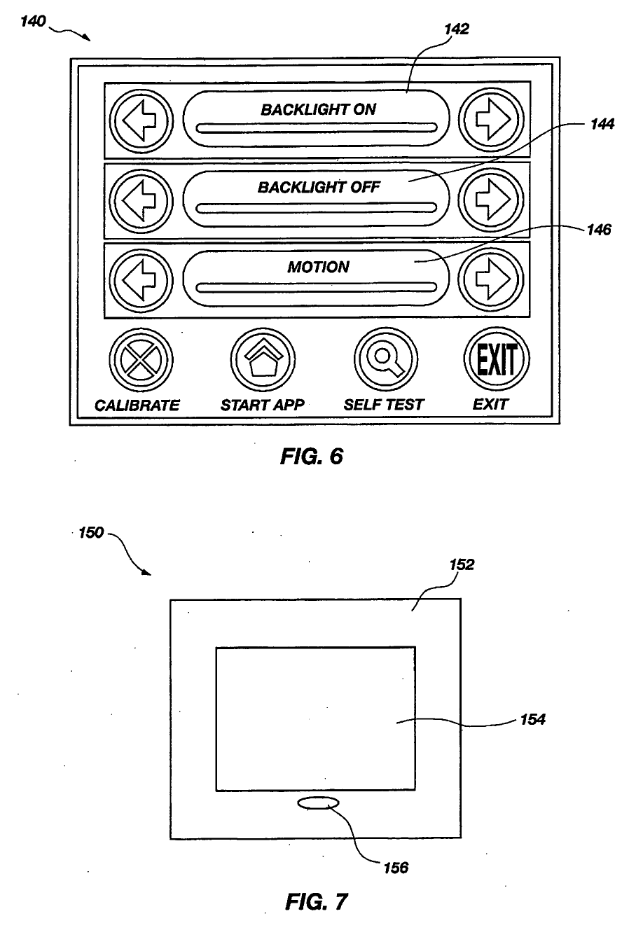

The display device 100 may also have setup pages for controlling various functions. For example, one function may include controlling screen/display 112 illumination or light level when the display/screen 112 is at a first illumination/light level (e.g., “off” or “dim”) or at a second illumination/light level (e.g., “on” or “high”). Another function may include controlling the sensitivity of the motion sensor 114. An example of one such page 140 is illustrated in FIG. 6.

For example, the illumination/light levels of the screen/display 112 may be adjusted/modified through control 142 so that the illumination/light is at a specific level when the screen/display 112 is “on” or at a “high” illumination/light level (e.g., when the screen/display 112 has been touched, and/or the motion sensor 114 has been tripped), and at a specific level when it is “off” or at a “dim” or “low” illumination/light level (e.g., when the screen/display 112 has not been touched for about 3 to about 3600 seconds, and/or the motion sensor 114 has not been tripped for about 3 to about 3600 seconds) through control 144. In exemplary embodiments, the display device 100 may be configured (e.g., through controls 142 and 144) to adjust/modify the screen illumination/light from one illumination/light level to a second illumination/light level at a specific amount of time after the non-contact motion sensor has detected at least one of motion or proximity of a human being. For example, the motion sensor 114 may be configured, adapted and/or programmed to activate or adjust the display/screen 112 from a first screen illumination/light level (e.g., “off” or “dim”) to a second screen illumination/light level (e.g., “on” or “high”) when the motion sensor detects motion, and then the motion sensor 114 (e.g., by using a processor or the like in communication with the motion sensor 114) may also be configured, adapted and/or programmed to change/adjust from the second screen illumination/light level (e.g., “on” or “high”) to the first screen illumination/light level (e.g., “off” or “dim”) after a specific amount of time (e.g., from about 3 seconds to about 3600 seconds) has elapsed from when the motion sensor last detected motion. In exemplary embodiments, the setting of the specific amount of time for when the display device changes/adjusts from the second screen illumination/light level to the first screen illumination/light level (e.g., the setting for the change/adjustment of the illumination/light level after a specific amount of time of inactivity and/or no motion/proximity sensed) may be adjusted by a user (e.g., by adjusting a control button or setting or the like).

In exemplary embodiments, the motion sensor 114 is used to activate and/or modify the intensity of the illumination/light level(s) of the screen/display 112 of the display device 100 when someone approaches or passes by the display device 100. In one embodiment, the sensitivity level of the motion sensor 114 may be adjusted by tapping the motion sensor left or right buttons on motion sensor control 146. For example, when the motion sensor sensitivity level is set all the way to the left or zero, the screen/display 112 and/or illumination means of the screen/display 112 will not respond (e.g., illuminate) and/or be modified (e.g., increase illumination) in response to motion, only to touch.

In an exemplary embodiment and as shown in FIG. 7, display device 100 may include a faceplate 150. The faceplate 150 may include a frame 152 having an opening 154 for the screen/display 112. The frame 152 may further include an aperture 156 for allowing the motion sensor 114 to detect movement. In addition, the aperture 156 may allow IR signals to pass to an IR receiver 116, if present.

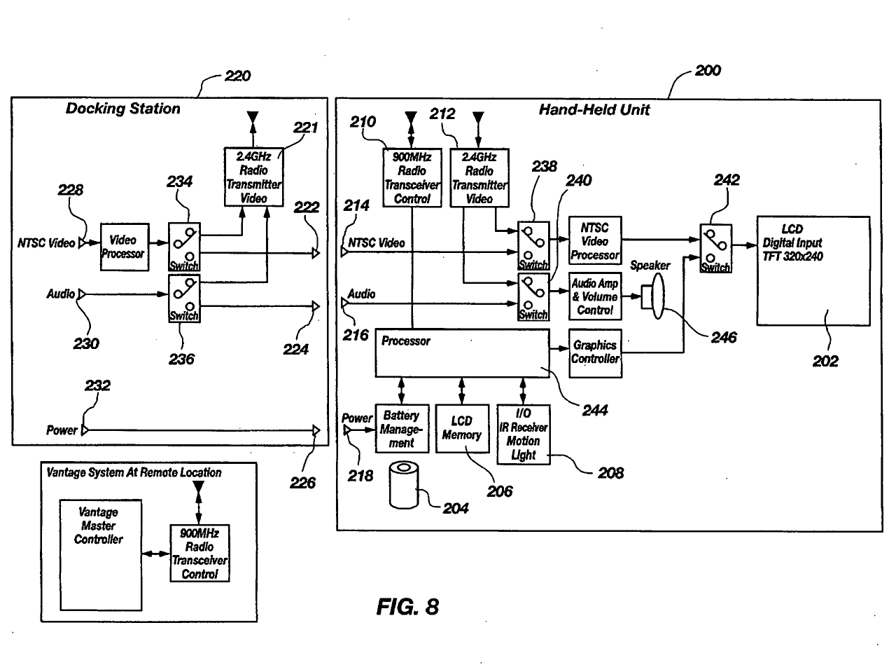

FIG. 8 illustrates another illustrative embodiment of the present disclosure in block diagram format. As shown in FIG. 8, display device 200 may be a hand-held display device. Hand-held display device 200 may include a screen/display 202 (e.g., a touchscreen or the like), a speaker 246, video-in feed 214, audio-in feed 216, a battery 204 (which may be rechargeable), memory 206 (storing screens for interfacing), I/O ports 208 (including IR receiver, motion and light sensors). Hand-held display device 200 may further include a first antenna 210 for sending and receiving data (including control and status information) and a second antenna 212 for receiving video and audio data. Hand-held display device 200 may be configured and dimensioned to mate with docking station 220.

In exemplary embodiments, switch 238 is operable to select a video data source between the second antenna 212 and the video-in feed 214. Switch 240 is operable to select an audio data source between the second antenna 212 and the audio-in feed 216. Switch 242 is operable to select a video source from between switch 238 and microprocessor 244.

Docking station 220 may include a video-in feed 228, an audio-in feed 230, a video-out feed 222 and an audio-out feed 224. Docking station 220 may further include an antenna 221 for transmitting audio and video data. In general, switch 234 is operable to select an output for incoming audio and video data between the antenna 221 and the video-out and audio out feeds, 222 and 224, respectively.

With the above configuration, when the hand-held display device 200 is docked in the docking station 220, the source for the video and audio data are the video-out feed 222 and audio-out feed 224. When the hand-held display device 200 is not docked, the source for the video and audio data may be the second antenna 212 (the docking station transmits the video and audio data from antenna 221 to the second antenna 212).

In addition, switch 242 allows a user to select source between the video and audio data or data generated by processor 244. In this manner, the hand-held display device 200 may use the video and audio data (such as images and sound from a security camera or a TV signal) or as a user interface.

Docking station 220 and hand-held display device 200 also may include corresponding power connections, 226 and 218, respectively. This may be used to recharge battery 204 and provide power when the hand-held display device 200 is mated with docking station 220.

Hand-held display device 200 may be programmable to control loads attached to an automation system 10. Typically, hand-held display device 200 allows remote control as long as the first antenna 210 is within range. As mentioned, hand-held display device 200 may be used to play audio and video.

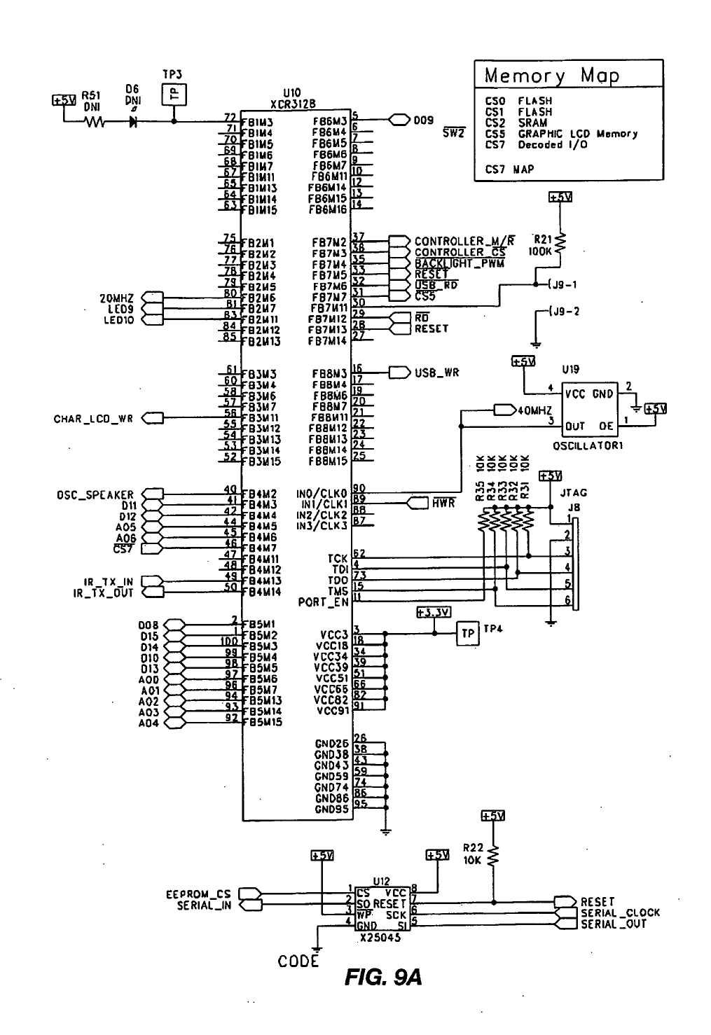

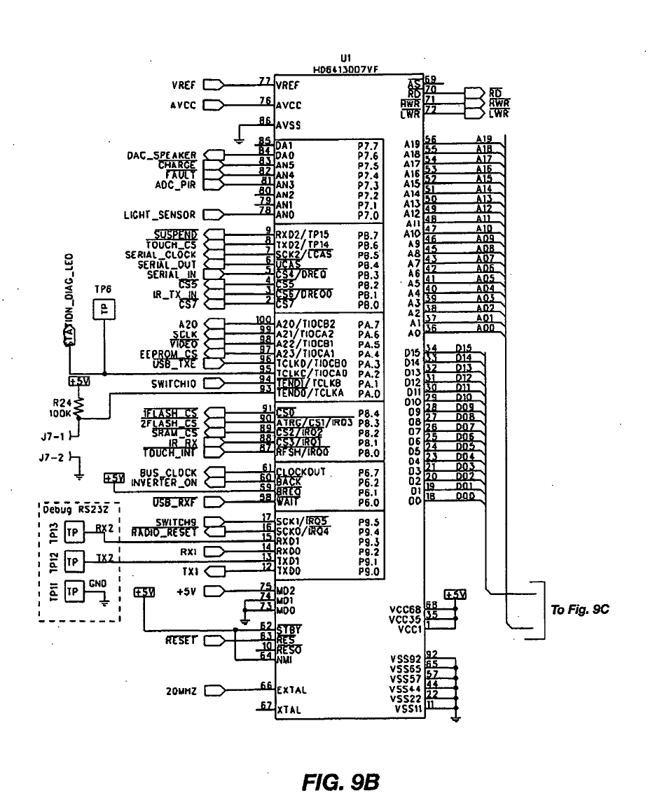

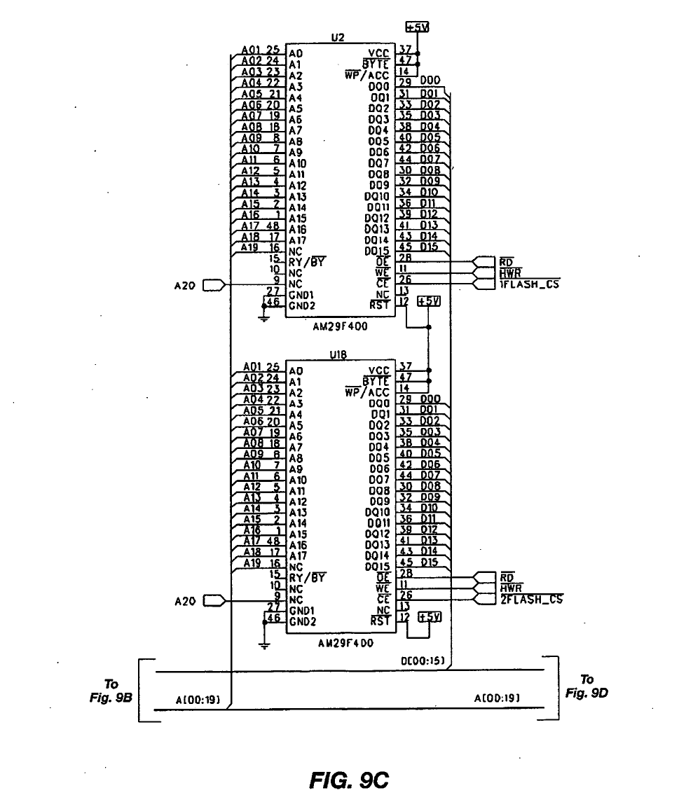

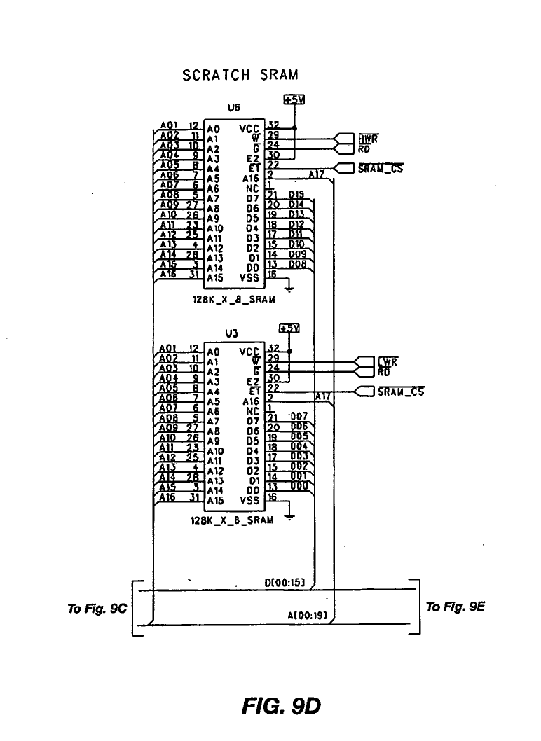

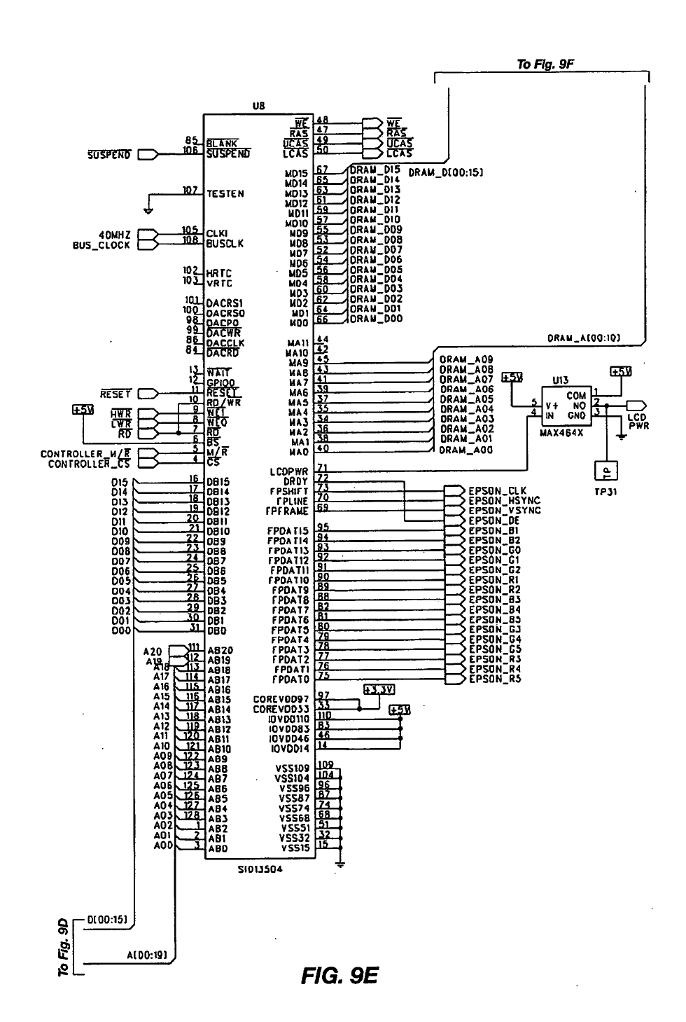

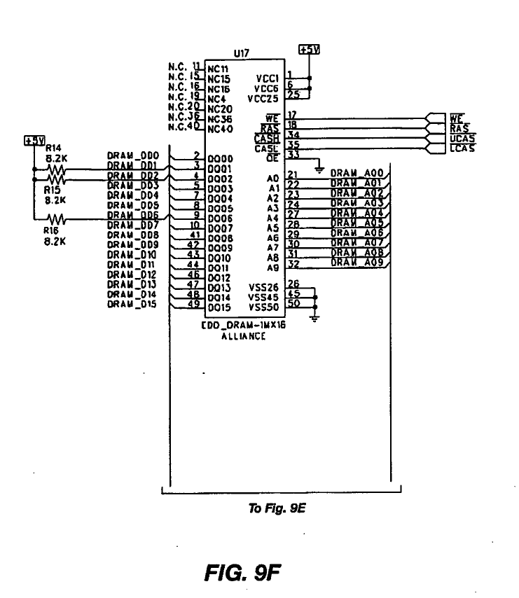

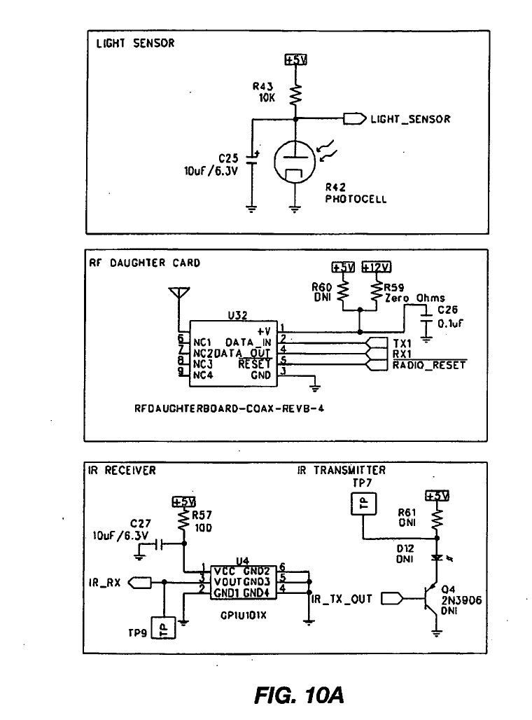

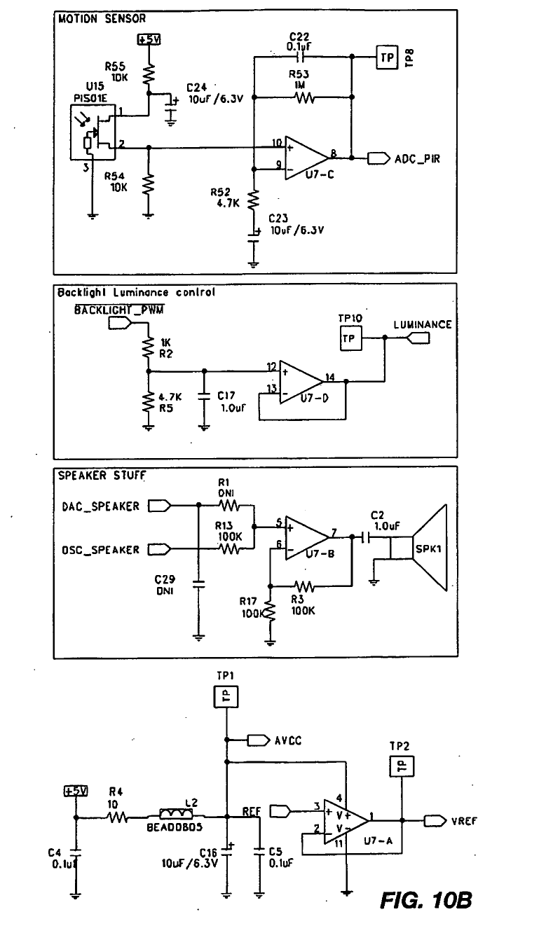

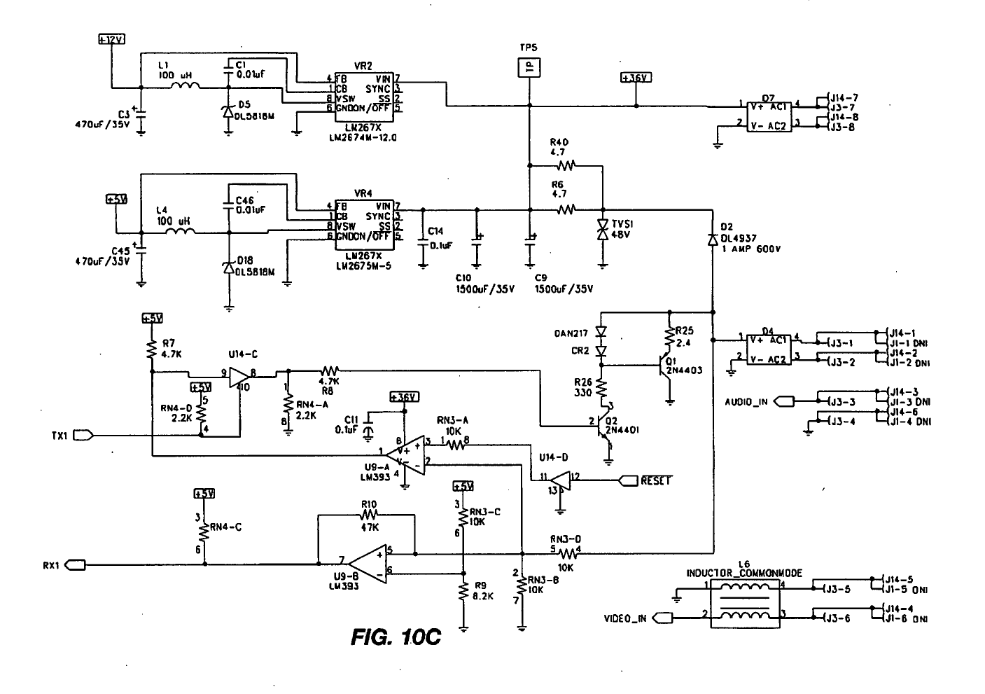

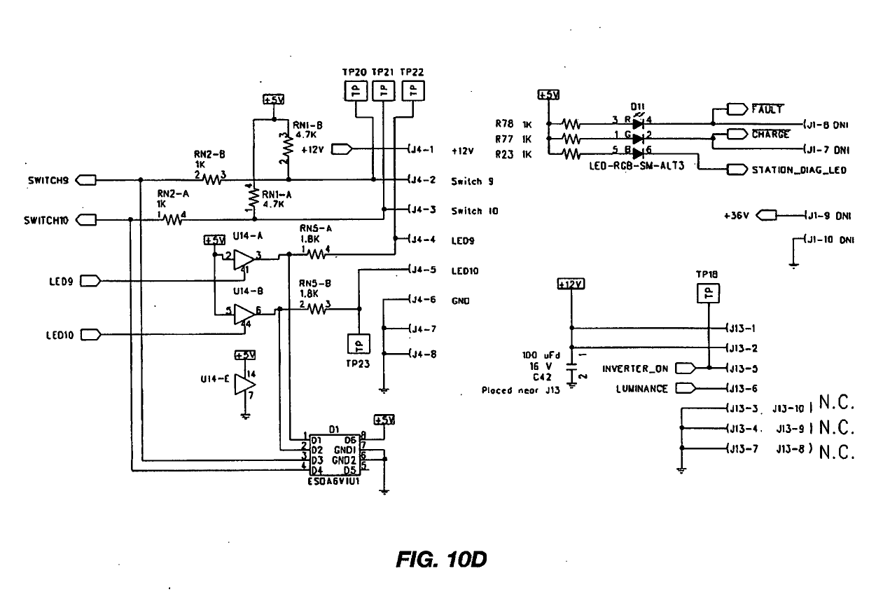

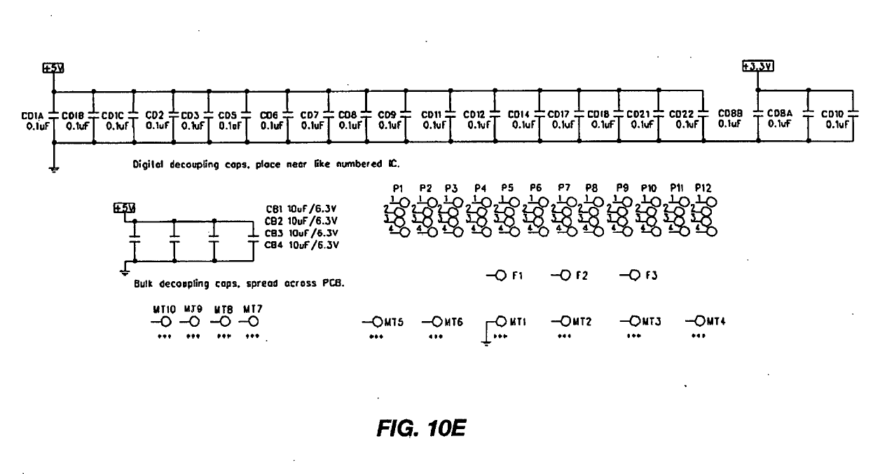

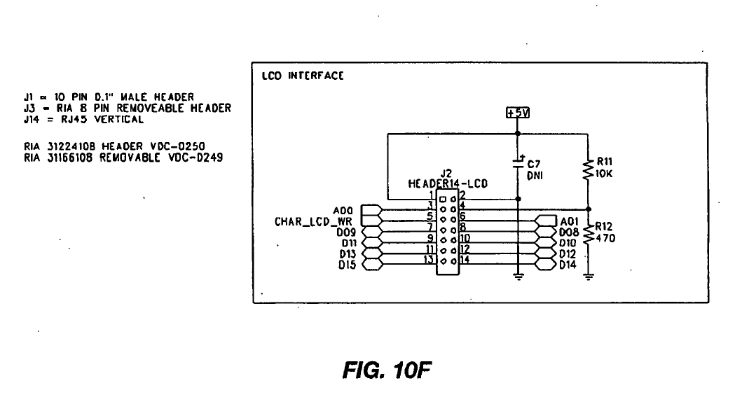

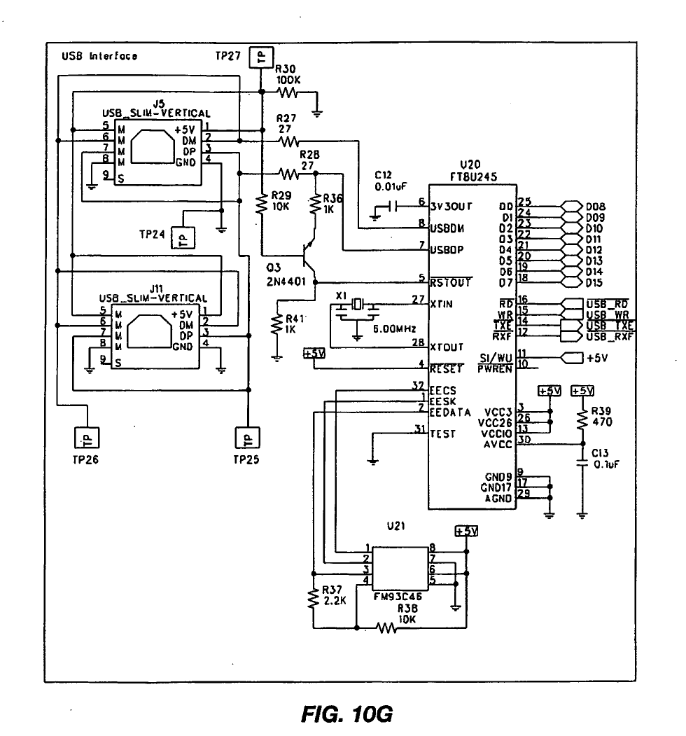

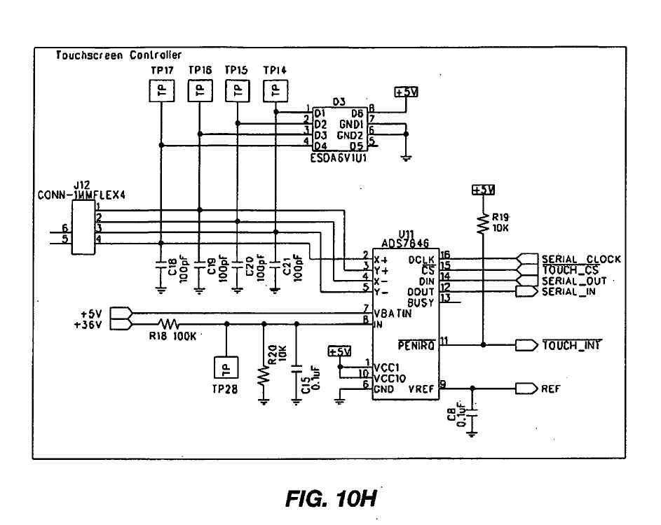

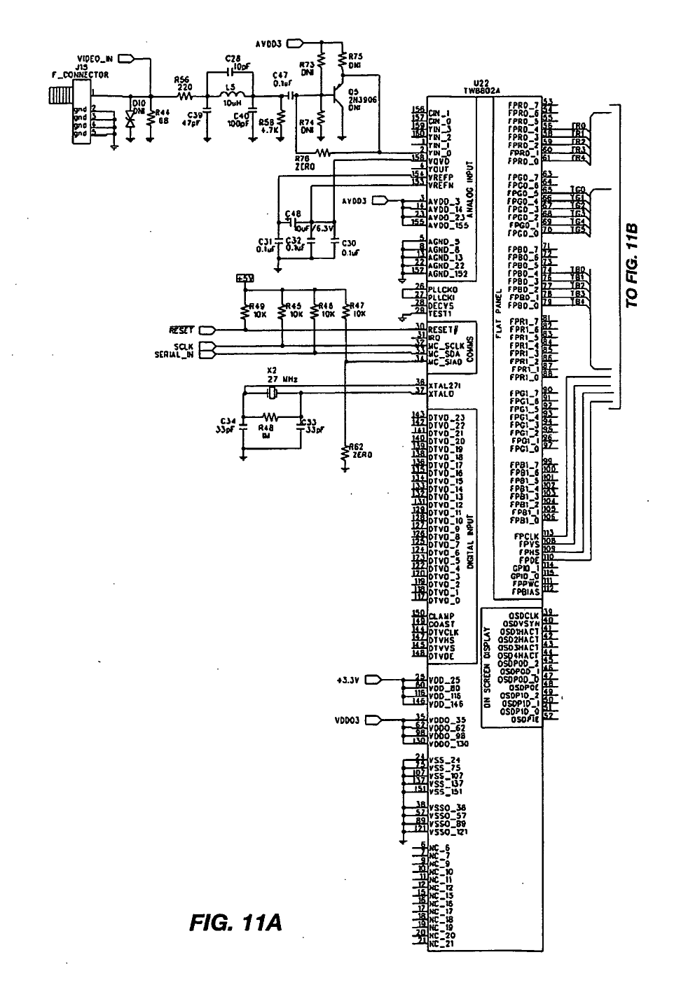

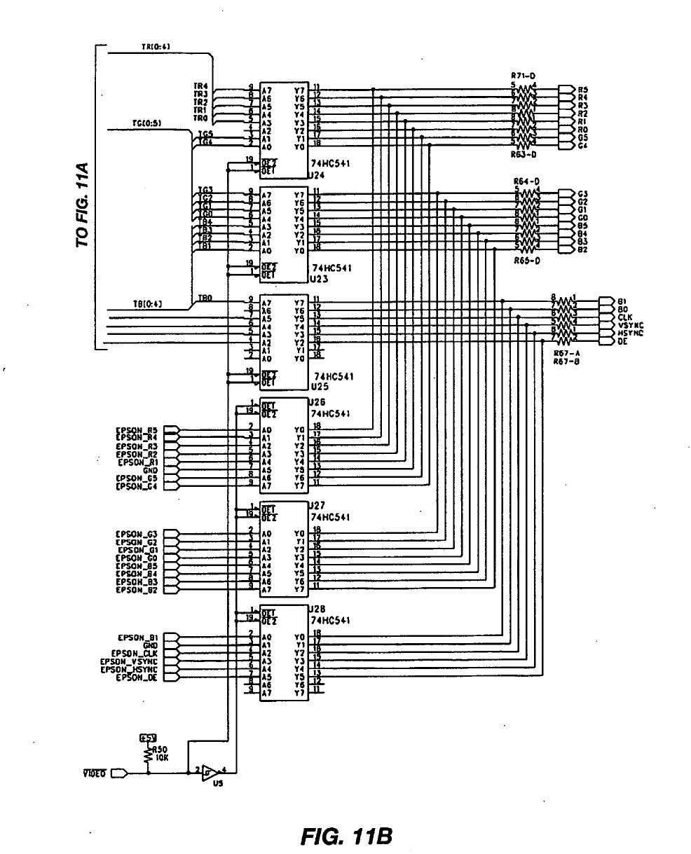

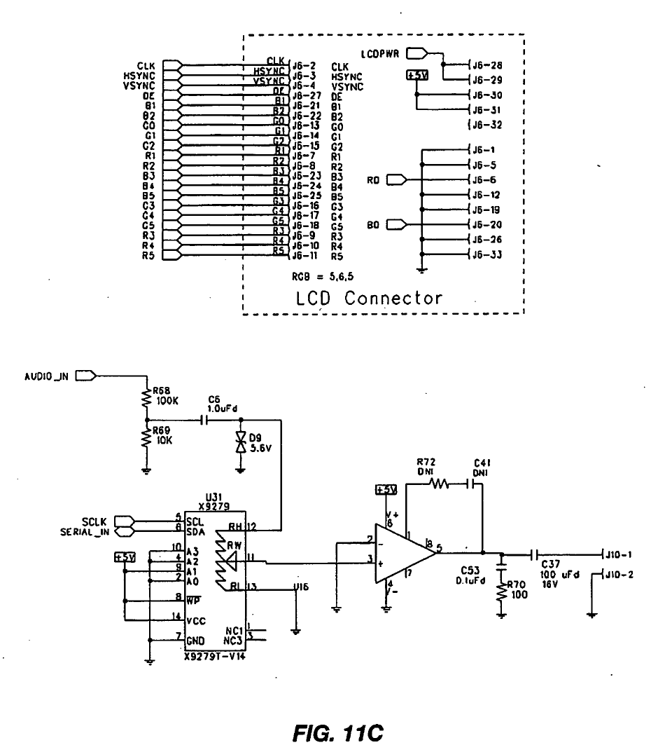

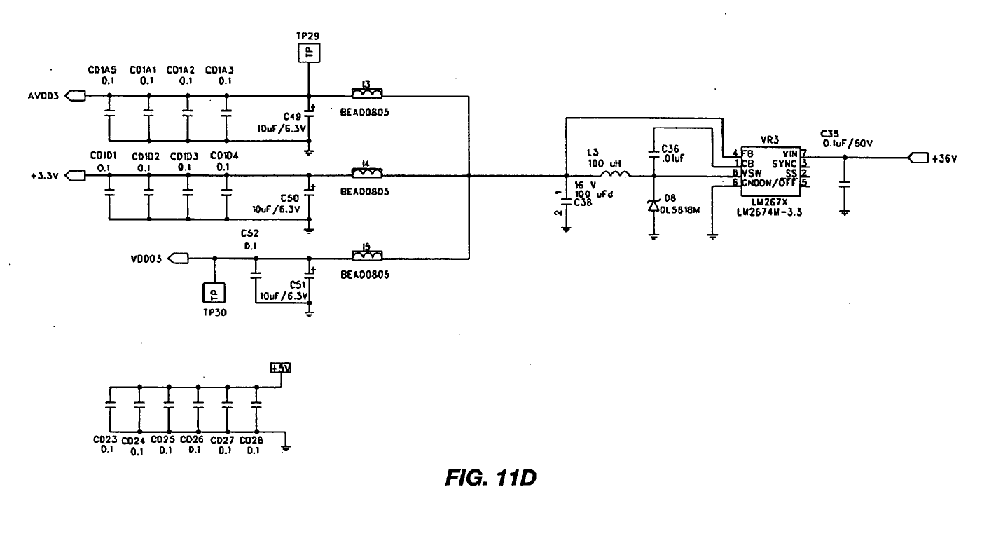

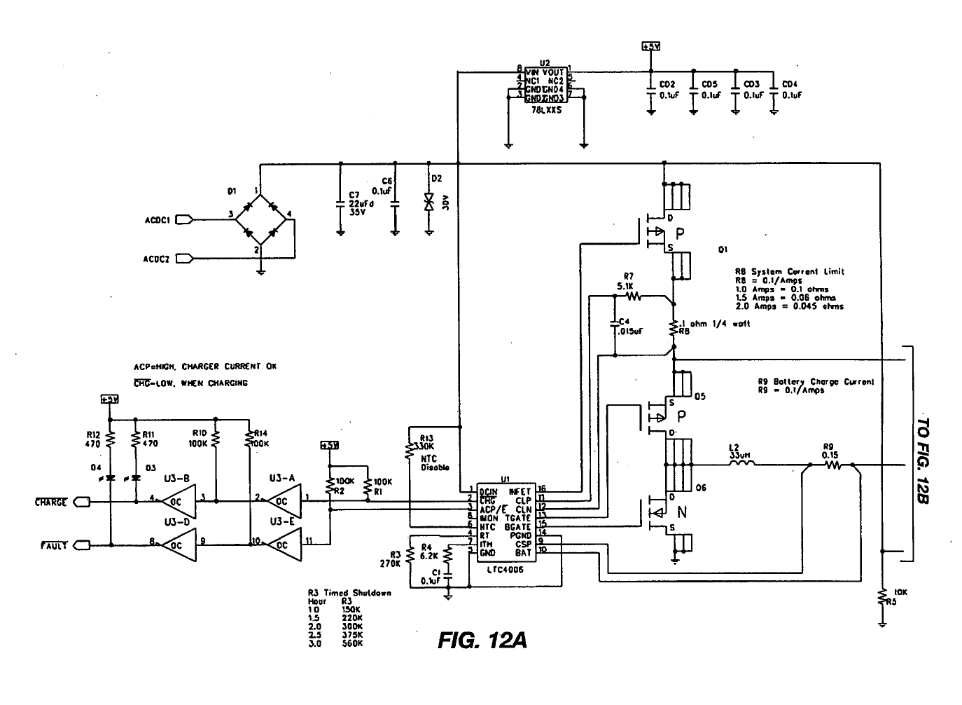

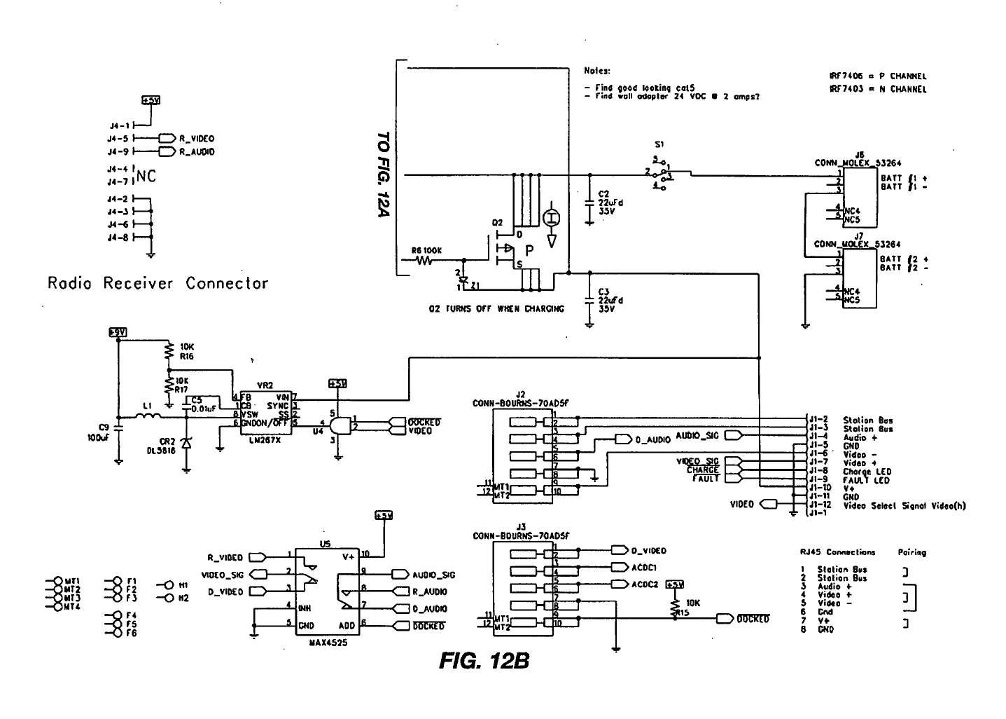

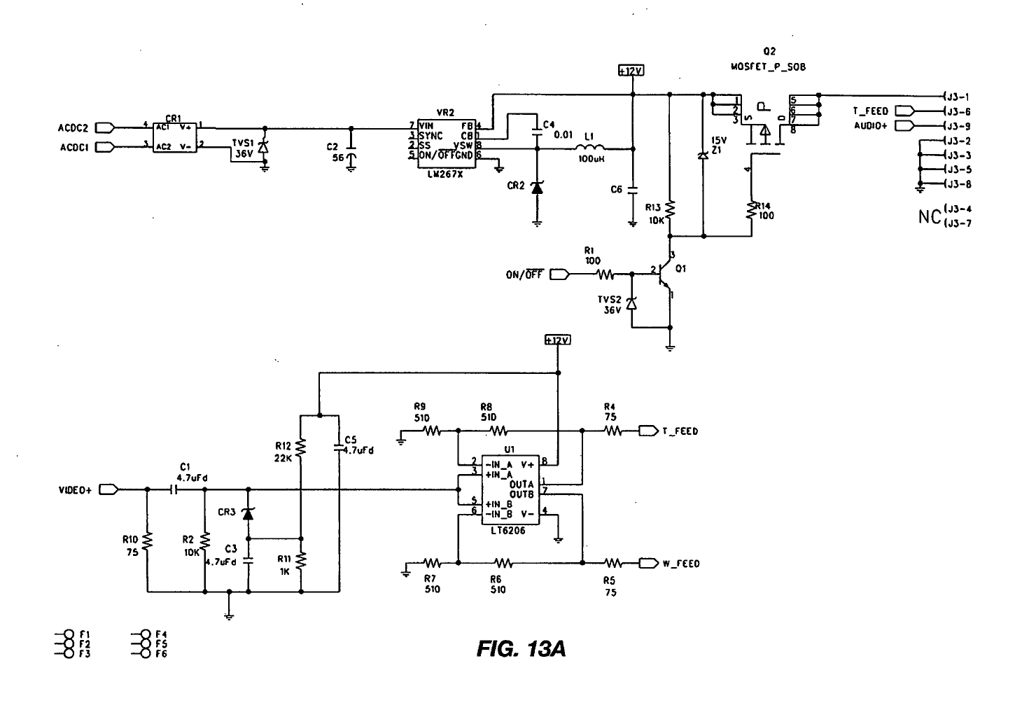

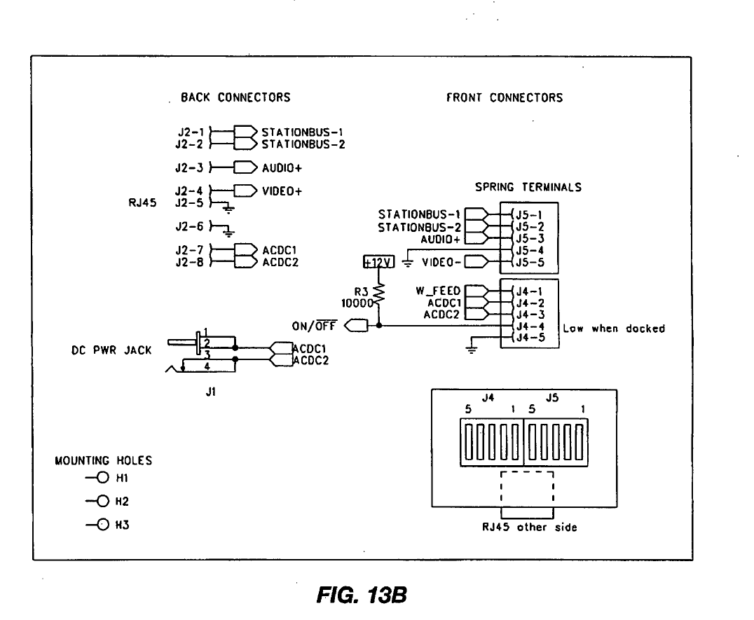

FIGS. 9-13 illustrate exemplary schematics for embodiments of the present disclosure. These schematics should not be viewed as limiting in any way on the scope of the present disclosure. Those skilled in the art will appreciate that other designs not specifically disclosed herein may nevertheless fall within the scope of the present disclosure.

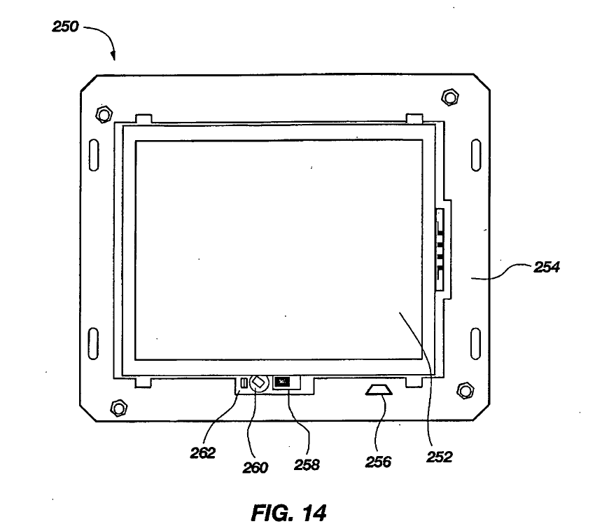

FIG. 14 illustrates a front view of display device 250 in accordance with an illustrative embodiment of the present disclosure. Display device 250 includes a screen/display 252 mounted in a housing 254. Display device 250 may also include a USB connection 256 (e.g., a mini-B USB connection), an IR receiver 258, a motion sensor 260, and an light sensor 262.

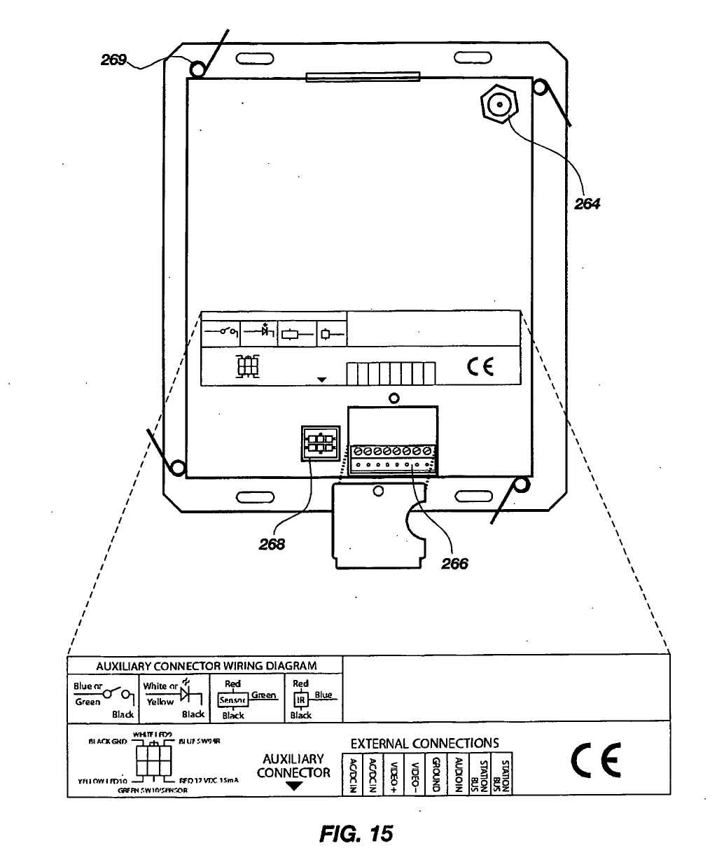

FIG. 15 illustrates a rear view of display device 250 in accordance with an illustrative embodiment of the present disclosure. Display device 250 may include a coaxial cable connection 264, connections 266 for connecting a station bus, audio, video, ground, power, and other desired devices or features. Auxiliary connections 268 may be used to connect contact inputs or other similar devices or sensors. Fasteners 269 may be used to fasten the display device 250 with respect to a surface (e.g., a wall surface).

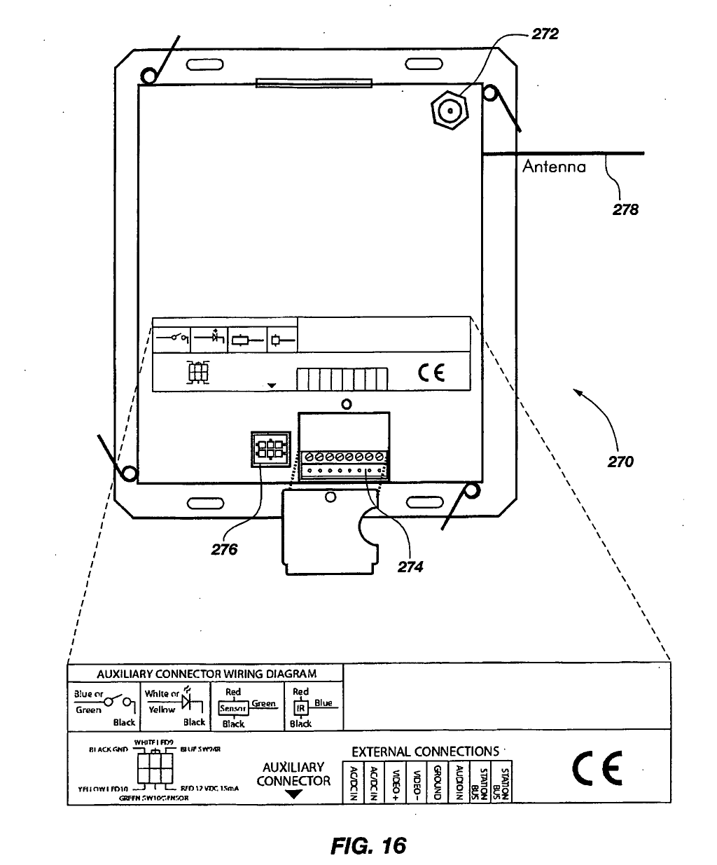

FIG. 16 illustrates a rear view of a display device 270 in accordance with an illustrative embodiment of the present disclosure. Display device 270 may be a coaxial cable connection 272, connections 274 for connecting a station bus, audio, video, ground, power, and other desired devices or features. Auxiliary connections 276 may be used to connect contact inputs or other similar devices or sensors. Antenna 278 may be used to send and receive signals.

Several different illustrative embodiments of the display devices of the present disclosure are possible. For example, the display device may be mounted with respect to a wall or in a wall box, or the display device may be free standing, or hand-held. In one embodiment, the display device includes an integrated screen/display and motion sensor. For example, the integrated screen/display may be an integrated touchscreen display. Alternatively, the integrated screen/display of the display device may not include a touchscreen. The integrated screen/display (with or without a touchscreen) may be, for example, a LCD screen/display, a LED screen/display, an OLED screen/display, a plasma or PDP screen/display, and a CRT screen/display.

Another embodiment includes a display device having an integrated screen/display, motion sensor, and IR receiver. The display device may include an integrated screen/display, motion sensor and any one of the following: a station bus, an external power supply input and auxiliary inputs. Another illustrative embodiment includes a display device having an integrated screen/display, motion sensor, IR receiver and any one of the following: a station bus, an external power supply input and auxiliary inputs. Another illustrative embodiment includes a display device that is a hand-held screen/display (e.g., touchscreen) having a docking station and optionally receiving control information and video and audio wirelessly.

Another illustrative embodiment includes a display device having a screen/display (e.g., a quarter VGA LCD display) having one or more of the following features: a proximity and/or motion sensor to active/modify the screen/display, an integrated IR receiver, status buttons (e.g., to display time, days of week, months, years, temperatures and/or lighting levels), programmable buttons and screens, an antenna for sending and receiving information wirelessly (including control information, status information, and audio and video), mounting wings, wall box installation, integrated video and audio input, auxiliary ports (for contact inputs, light sensors, motion sensors and other auxiliary devices), station bus connector, mini-B USB connector, USB connector, a first antenna for receiving data and a second antenna for receiving audio and video, a battery (including a rechargeable battery), docking station connections (for receiving power, audio and video), coaxial cable connection, auto light sensor, memory, speaker, as well as other connections. The above illustrative embodiments should not be construed as limiting any other embodiments of the present disclosure in any way.

It will be appreciated that a motion sensor as disclosed herein is merely one example of a means for detecting the proximity or motion of a human being, and it should be appreciated that any structure, apparatus or system for detecting the proximity or motion of a human being which performs functions the same as, or equivalent to, those disclosed herein are intended to fall within the scope of a means for detecting the proximity or motion of a human being, including those structures, apparatus or systems for detecting the proximity or motion of a human being which are presently known, or which may become available in the future. Anything which functions the same as, or equivalently to, a means for detecting the proximity or motion of a human being falls within the scope of this element.

It will be appreciated that a display device as disclosed herein is merely one example of a means for interfacing with a control system, and it should be appreciated that any structure, apparatus or system for interfacing with a control system which performs functions the same as, or equivalent to, those disclosed herein are intended to fall within the scope of a means for interfacing with a control system, including those structures, apparatus or systems for interfacing with a control system which are presently known, or which may become available in the future. Anything which functions the same as, or equivalently to, a means for interfacing with a control system falls within the scope of this element.

It will be appreciated that an IR receiver as disclosed herein is merely one example of a means for receiving wireless commands, and it should be appreciated that any structure, apparatus or system for receiving wireless commands which performs functions the same as, or equivalent to, those disclosed herein are intended to fall within the scope of a means for receiving wireless commands, including those structures, apparatus or systems for receiving wireless commands which are presently known, or which may become available in the future. Anything which functions the same as, or equivalently to, a means for receiving wireless commands falls within the scope of this element.

Those having ordinary skill in the relevant art will appreciate the advantages provided by the features of the present disclosure. For example, it is a feature of the present disclosure to provide a display device for interfacing with a control system. Another feature of the present disclosure is to provide a motion sensor such that the life of the display device and/or illumination means of the display device is extended. It is a further feature of the present disclosure, in accordance with one aspect thereof, to provide an integrated display device having a screen/display, motion sensor and IR receiver.

It is to be understood that the above-described arrangements are only illustrative of the application of the principles of the present disclosure. Numerous modifications and alternative arrangements may be devised by those skilled in the art without departing from the spirit and scope of the present disclosure and the appended claims are intended to cover such modifications and arrangements. Thus, while the present disclosure has been shown in the drawings and described above with particularity and detail, it will be apparent to those of ordinary skill in the art that numerous modifications, including, but not limited to, variations in size, materials, shape, form, function and manner of operation, assembly and use may be made without departing from the principles and concepts set forth herein.

Although the systems and methods of the present disclosure have been described with reference to exemplary embodiments thereof, the present disclosure is not limited to such exemplary embodiments and/or implementations. Rather, the systems and methods of the present disclosure are susceptible to many implementations and applications, as will be readily apparent to persons skilled in the art from the disclosure hereof. The present disclosure expressly encompasses such modifications, enhancements and/or variations of the disclosed embodiments. Since many changes could be made in the above construction and many widely different embodiments of this disclosure could be made without departing from the scope thereof, it is intended that all matter contained in the drawings and specification shall be interpreted as illustrative and not in a limiting sense. Additional modifications, changes, and substitutions are intended in the foregoing disclosure. Accordingly, it is appropriate that the appended claims be construed broadly and in a manner consistent with the scope of the disclosure.

What is claimed is:

1. A display device comprising:
a screen adapted to display information related to an automation system, the screen having adjustable illumination levels that include at least a first illumination level and a second illumination level;
a non-contact motion sensor configured to detect at least one of motion or proximity of a human being without being contacted by the human being; and
wherein the non-contact motion sensor is configured to activate or adjust the illumination level of the screen from the first illumination level to the second illumination level when the non-contact motion sensor detects at least one of motion or proximity of a human being.

2. The device of claim 1 wherein the screen is selected from the group consisting of a liquid crystal display (LCD) screen, a light-emitting diode (LED) screen, an organic light-emitting diode (OLED) screen, a plasma or plasma display panel (PDP) screen and a cathode ray tube (CRT) screen.

3. The device of claim 1 wherein the screen further comprises a touchscreen.

4. The device of claim 1 wherein the screen is a self-illuminating screen.

5. The device of claim 1 wherein the non-contact motion sensor is selected from the group consisting of a pyro infra-red (PIR) sensor, a RF field disruption sensor, a capacitive field change sensor, a light level sensor, a reflective light measurement sensor and an acoustic sensor.

6. The device of claim 1 wherein the screen is in communication with at least one master controller of the automation system, and wherein the screen further comprises a station bus configured to allow two-way communication between the screen and the master controller.

7. The device of claim 1 wherein the screen further comprises at least one auxiliary input configured to receive data from external devices.

8. The device of claim 1 wherein the first illumination level is non-illuminated.

9. The device of claim 1 wherein the non-contact motion sensor has adjustable motion or proximity sensitivity levels.

10. The device of claim 1 further comprising:
a first screen illumination level control configured to allow a user to adjust the illumination of the first illumination level; and
a second screen illumination level control configured to allow a user to adjust the illumination of the second illumination level.

11. The device of claim 1 further comprising a housing and an IR receiver; and
wherein the screen, non-contact motion-sensor and IR receiver are mounted with respect to the housing.

12. The device of claim 11, wherein the IR receiver is configured to receive command signals from a remote to control at least one electrical device connected to the automation system.

13. The device of claim 11 further comprising a communications port mounted with respect to the housing.

14. The device of claim 1 further comprising a non-contact motion sensor control configured to allow a user to adjust the sensitivity level of the non-contact motion sensor.

15. The device of claim 1 wherein the screen further comprises at least one of the following: an external power supply input, at least one auxiliary input and a station bus.

16. The device of claim 1 further comprising:
a housing;
a first antenna in communication with at least one master controller of the automation system, the first antenna configured to send load control or status information to the master controller and to receive load control or status information from the master controller; and
wherein the screen, non-contact motion sensor and first antenna are mounted with respect to the housing.

17. The device of claim 16 further comprising a second antenna in communication with a docking station, the second antenna configured to receive audio or video data from the docking station.

18. The device of claim 16 wherein the housing is configured and dimensioned to be hand-held by a user.

19. The device of claim 16 wherein the housing further comprises at least one connection configured to allow a user to releasably engage the housing to a docking station.

20. The device of claim 16 further comprising an IR receiver mounted with respect to the housing.

21. The device of claim 16 further comprising a light sensor mounted with respect to the housing.

22. The device of claim 1 further comprising:
a housing;
a radio transceiver in communication with a docking station, the radio transceiver configured to receive video or audio data from the docking station;
a radio transmitter in communication with at least one master controller of the automation system, the radio transmitter configured to send load control signals to the at least one master controller of the automation system; and
wherein the screen, non-contact motion sensor, radio transceiver and radio transmitter are mounted with respect to the housing.

23. A display device comprising:
a screen adapted to display information related to an automation system, the screen having adjustable illumination levels that include at least a first illumination level and a second illumination level;
a non-contact motion sensor configured to detect at least one of motion or proximity of a human being without being contacted by the human being;
wherein the non-contact motion sensor is configured to activate or adjust the illumination level of the screen from the first illumination level to the second illumination level when the non-contact motion sensor detects at least one of motion or proximity of a human being; and
wherein the motion sensor is configured to adjust the screen illumination from the second illumination level to the first illumination level after a specific amount of time has elapsed from when the non-contact motion sensor last detected at least one of motion or proximity of a human being.

24. The device of claim 23 wherein the specific amount of time may be adjusted.

25. A display device comprising:
a display means for displaying information related to an automation system, the display means having adjustable illumination levels that include at least a first illumination level and a second illumination level;
a non-contact sensor means for detecting at least one of motion or proximity of a human being without being contacted by the human being; and
wherein the non-contact sensor means is configured to activate or adjust the illumination level of the screen from the first illumination level to the second illumination level.
